(19) United States
(12) Patent Application Publication
(10) Pub. No.: US 2026/0185875 A1
(43) Pub. Date: Jul. 2, 2026

(54) Dark Spot Detection Method and Apparatus for Display Panel, and Computer Readable Storage Medium

(71) Applicants: Yunnan Invensight Optoelectronics Technology Co., Ltd., Kunming, Yunnan (CN); BOE Technology Group Co., Ltd., Beijing (CN); Beijing BOE Technology Development Co., Ltd., Beijing (CN)

(72) Inventors: Chao PU, Beijing (CN); Dacheng ZHANG, Beijing (CN); Qingshan SHAN, Beijing (CN); Xiaochuan CHEN, Beijing (CN); Yinhu HUANG, Beijing (CN); Shengji YANG, Beijing (CN); Pengcheng LU, Beijing (CN); Zhao MA, Beijing (CN); Yingbing ZHANG, Beijing (CN); Liuzeming QU, Beijing (CN); Qi SU, Beijing (CN); Zhuoyang XIE, Beijing (CN)

(21) Appl. No.: 18/834,616

(22) PCT Filed: Sep. 20, 2023
(86) PCT No.: PCT/CN2023/120113

§ 371 Date: Jul. 30, 2024

(51) Int. Cl. G01J 3/50; G09G 3/3225

(52) U.S. Cl. CPC G01J 3/506; G09G 3/3225

(57) ABSTRACT

A dark spot detection method and apparatus for a display panel and a computer-readable storage medium. The dark spot detection method includes: acquiring first luminances of multiple sub-pixels at a first viewing angle; acquiring a first mapping relationship between first distance and chief ray angle, wherein the first distance is a distance from a sub-pixel to a center of a display area, the chief ray angle is an included angle between a direction in which luminous intensity of the sub-pixel is greatest and a direction perpendicular to the display panel; acquiring luminances of a single sub-pixel at multiple viewing angles, obtaining a second mapping relationship between viewing angle and luminance of the single sub-pixel; determining second luminances of multiple sub-pixels at chief ray angles according to first luminances, first mapping relationship, and second mapping relationship, marking a sub-pixel whose second luminance is lower than a luminance threshold as dark spot.

### CROSS-REFERENCE TO RELATED APPLICATION

The present application is a U.S. National Phase Entry of International Application No. PCT/CN2023/120113 having an international filing date of Sep. 20, 2023, the content of which is hereby incorporated by reference.

### TECHNICAL FIELD

Embodiments of the present disclosure relate to, but are not limited to, the field of display panel detection technologies, and more particularly, to a dark spot detection method and apparatus for a display panel, and a computer-readable storage medium.

### BACKGROUND

With the increasing progress of virtual reality/augmented reality (VR/AR) technology and the rapid growth of the market, display panels suitable for the VR/AR field are also developing in the direction of miniaturization, high Pixels Per Inch (PPI), fast response and high color gamut, and a silicon-based Organic Light emitting Diode (OLED) microdisplay panel is one of the prominent directions. Although silicon-based OLED microdisplay technology started late, it is becoming a new focus in the display field with its advantages of miniaturization and high PPI

In the manufacturing process of silicon-based OLED microdisplays, poor pixel points are an inevitable defect in the manufacturing process. In order to ensure the factory quality of the display panel, it is necessary to detect sub-pixel dark spots on the display panel before the display panel leaves the factory.

### SUMMARY

The following is a summary of subject matters described herein in detail. This summary is not intended to limit the protection scope of claims.

An embodiment of the present disclosure provides a dark spot detection method for a display panel, including:
acquiring first luminances of a plurality of sub-pixels at a first viewing angle;
acquiring a first mapping relationship between a first distance and a chief ray angle, wherein the first distance is a distance from a sub-pixel to a center of a display area of the display panel, the chief ray angle is an included angle between a direction in which a luminous intensity of the sub-pixel is greatest and a direction perpendicular to the display panel;
acquiring luminances of a single sub-pixel at a plurality of viewing angles, and obtaining a second mapping relationship between the viewing angle and the luminance of the single sub-pixel; and
determining second luminances of the plurality of sub-pixels at chief ray angles according to the acquired first luminances, the acquired first mapping relationship, and the acquired second mapping relationship, and marking a sub-pixel whose second luminance is lower than a luminance threshold as a dark spot.

An embodiment of the present disclosure further provides a dark spot detection apparatus for a display panel, including: a first acquisition module, a second acquisition module, a third acquisition module and a first processing module.

The first acquisition module is configured to acquire first luminances of a plurality of sub-pixels at a first viewing angle.

The second acquisition module is configured to acquire a first mapping relationship between a first distance and a chief ray angle, wherein the first distance is a distance from a sub-pixel to a center of a display area of the display panel, and the chief ray angle is an included angle between a direction in which a luminous intensity of the sub-pixel is greatest and a direction perpendicular to the display panel.

The third acquisition module is configured to acquire luminances of a single sub-pixel at a plurality of viewing angles, and to obtain a second mapping relationship between a viewing angle and luminance of the single sub-pixel.

The first processing module is configured to determine second luminances of the plurality of sub-pixels at chief ray angles according to the acquired first luminances, the acquired first mapping relationship, and the acquired second mapping relationship, and to mark a sub-pixel whose second luminance is lower than a luminance threshold as a dark spot.

An embodiment of the present disclosure further provides a dark spot detection apparatus for a display panel, including a memory, and a processor connected to the memory, the memory is configured to store instructions, the processor is configured to perform act of the dark spot detection method for a display panel according to any embodiment of the present disclosure based on the instructions stored in the memory.

An embodiment of the present disclosure further provides a computer-readable storage medium having stored thereon a computer program, when the computer program is executed by a processor, the dark spot detection method for the display panel according to any embodiment of the present disclosure is implemented.

Other aspects may be comprehended upon reading and understanding drawings and detailed description.

### BRIEF DESCRIPTION OF DRAWINGS

Accompanying drawings are used for providing further understanding of technical solutions of the present disclosure, constitute a portion of the specification, and are used for explaining the technical solutions of the present disclosure together with embodiments of the present disclosure, but do not constitute limitations on the technical solutions of the present disclosure. Shapes and sizes of various components in the drawings do not reflect actual scales, but are only intended to schematically illustrate contents of the present disclosure.

FIG. 1 is a schematic diagram of a sub-pixel dark spot of a display panel.

FIG. 2 is a schematic diagram of a variation curve of a chief ray angle of an optical lens corresponding to a display panel and a chief ray angle of a micro-lens of a display panel with a first distance.

FIG. 3 is a schematic diagram of luminance variation curves of several silicon-based OLED display panels with temperature.

FIG. 4A is a flowchart of a dark spot detection method for a display panel according to an exemplary embodiment of the present disclosure.

FIG. 4B is a schematic diagram of a sectional structure of a display panel according to an embodiment of the present disclosure.

FIG. 4C is a top view of a display panel according to an exemplary embodiment of the present disclosure.

FIG. 4D is a schematic diagram showing distribution of chief ray angles of a display panel in a column direction according to an exemplary embodiment of the present disclosure.

FIG. 4E is a schematic diagram showing distribution of chief ray angles of a display panel in a row direction according to an exemplary embodiment of the present disclosure.

FIG. 5 and FIG. 6 are schematic diagrams showing first luminance information acquisition of a display panel according to an exemplary embodiment of the present disclosure.

FIG. 7 is a schematic diagram of a luminance curve of a single sub-pixel of a display panel at different viewing angles according to an exemplary embodiment of the present disclosure.

FIG. 8 is a schematic diagram of sub-pixel sampling positions at different first distances according to an exemplary embodiment of the present disclosure.

FIG. 9A to FIG. 9D are schematic diagrams of luminance variation curves, obtained from a test, of sub-pixels at different first distances in FIG. 8 with viewing angles.

FIG. 10 is a schematic diagram of a structure of a dark spot detection apparatus for a display panel according to an exemplary embodiment of the present disclosure.

FIG. 11 is a schematic diagram of a structure of another dark spot detection apparatus for a display panel according to an exemplary embodiment of the present disclosure.

FIG. 12 is a schematic diagram of a structure of still another dark spot detection apparatus of a display panel according to an exemplary embodiment of the present disclosure.

### DETAILED DESCRIPTION

To make the objectives, technical solutions, and advantages of the present disclosure clearer, the embodiments of the present disclosure will be described in detail below with reference to the accompany drawings. It needs to be noted that the embodiments and features in the embodiments of the present disclosure may be randomly combined with each other if there is no conflict.

Unless otherwise defined, technical terms or scientific terms used in the embodiments of the present disclosure should have usual meanings understood by those of ordinary skills in the art to which the present disclosure belongs. “First”, “second”, and similar terms used in the embodiments of the present disclosure do not represent any order, quantity, or importance, but are only used for distinguishing different components. “Include”, “contain”, or a similar word means that an element or article appearing before the word covers an element or article and equivalent thereof listed after the word, and other elements or articles are not excluded.

With continuous development of display technologies, silicon-based OLED display panels have attracted widespread attention due to its advantages of high resolution, low power consumption, small size, and light weight, etc., and they have good application prospects in the near-eye display industry with high-resolution, such as wearable devices, industrial security, and medical care. In order to perform display defect (Demura) compensation on a silicon-based OLED display panel, it is necessary to first detect sub-pixel dark spots.

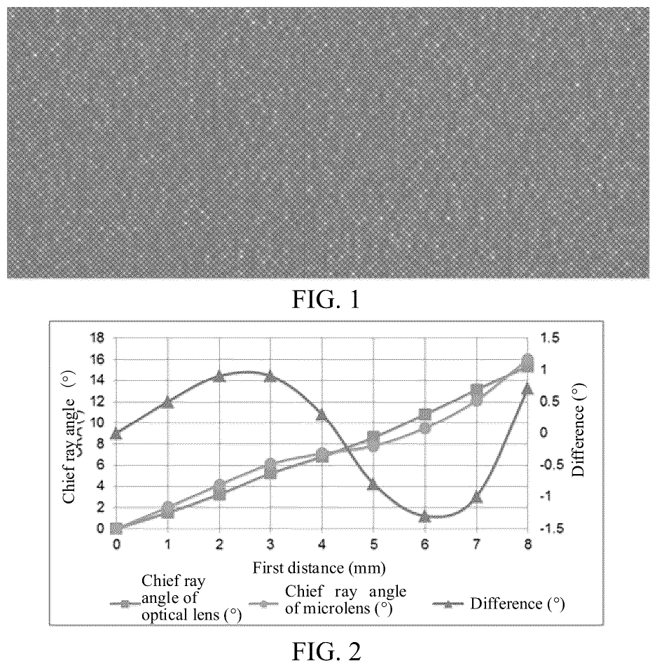

FIG. 1 is a schematic diagram of sub-pixel dark spots of a display panel. White dots in FIG. 1 are dark dots, and the brighter the white dots, the lower the luminance of the dark dots. Before Demura compensation for these sub-pixel dark spots are performed, it is necessary to accurately detect the number and coordinates of these sub-pixel dark spots.

At present, approaches used in the industry to detect dark spots on a display panel include the following three approaches.

(1) Visual effect detection: that is, it mainly relies on manual detection, and this approach cannot accurately output the number and coordinates of sub-pixel dark spots.

(2) Sub-pixel voltage or current information detection: sub-pixel dark spots caused by low efficiency of the light emitting unit cannot be detected.

(3) Luminance detection of a plurality of sub-areas of a display panel: it cannot be applied to dark spot detection of a micro OLED display panel with a chief ray angle (CRA), and the influence of temperature on sub-pixel luminance cannot be excluded.

Near-eye display devices such as virtual reality devices and augmented reality devices may include a display panel and an optical lens. The optical lens is arranged on a light emitting side of the display panel (usually worn on a user's head for usage), and used for adjusting an optical path of the display panel, and forming an image that can be viewed by the user in a designated space. The display panel may include a plurality of light emitting devices and a plurality of micro-lenses. Various micro-lenses are arranged on the light emitting side of the light emitting devices, and are arranged in one-to-one correspondence with various light emitting devices (or a plurality of light emitting devices may correspond to one micro-lens). Through the micro-lens, the light emitted by the light emitting devices can converge to a specified range, avoiding excessive divergence of the light, thereby improving the luminance of the display panel through the lenses. FIG. 2 is a schematic diagram of a variation curve of a chief ray angle of an optical lens corresponding to a display panel and a chief ray angle of a micro-lens of a display panel with a first distance, wherein the first distance refers to a distance from any point on the display panel to a center of a display area of the display panel. As can be seen from FIG. 2, as the first distance increases, a chief ray angle value of the optical lens and a chief ray angle value of the micro-lens gradually increase, but the current dark spot detection method for the display panel is only applicable to the luminance acquisition of the display panel without a chief ray angle.

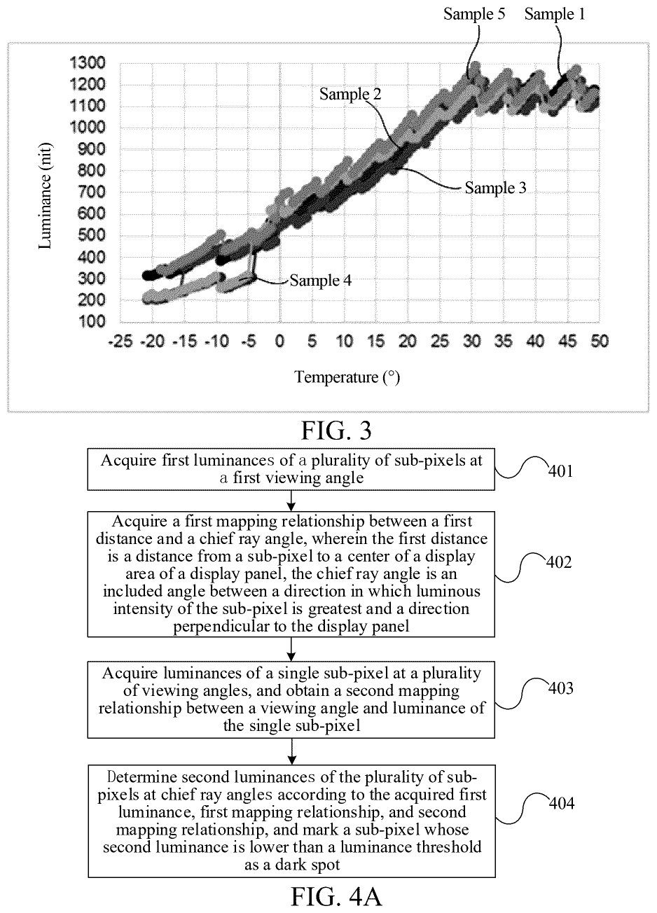

FIG. 3 is a schematic diagram of luminance variation curves of several silicon-based OLED display panels with temperature. As can be seen from FIG. 3, at different temperatures, the luminance of the silicon-based OLED display panel is different due to the different light emitting efficiencies of a light emitting unit. The current dark spot detection methods for the display panel cannot exclude the influence of temperature on the luminance of the silicon-based OLED display panel.

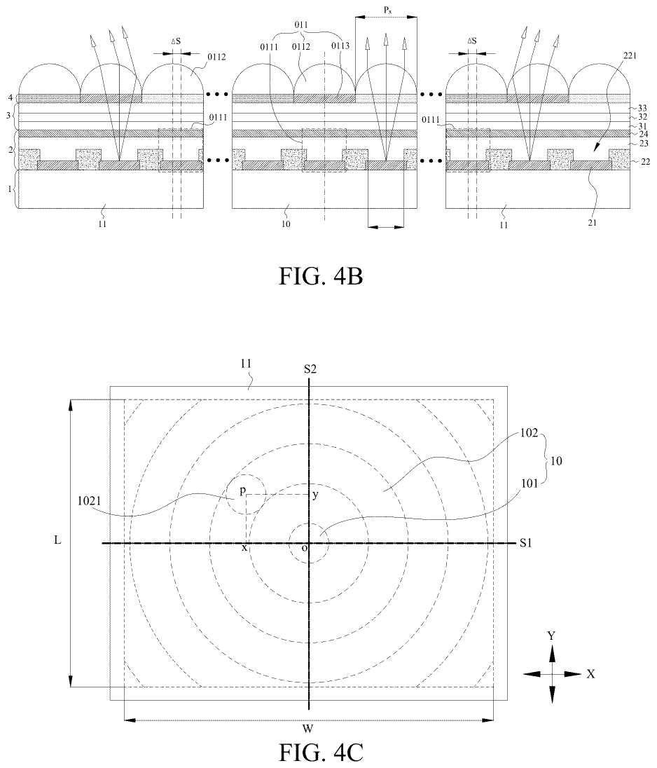

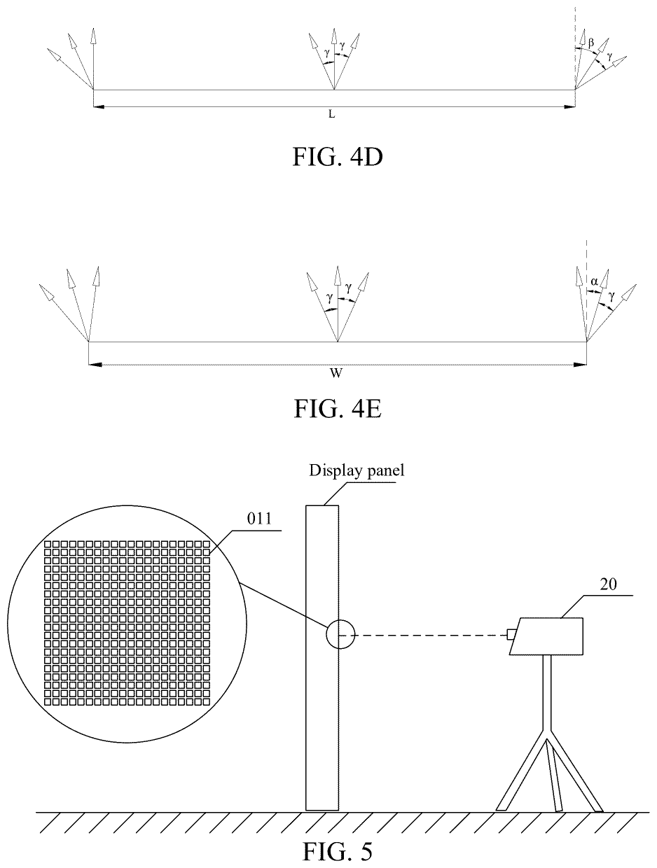

As shown in FIG. 4A, an embodiment of the present disclosure provides a dark spot detection method for a display panel. A plurality of micro-lens structures are provided on a light emitting surface of a display panel, and the dark spot detection method includes the following acts 401-404.

In act 401, first luminances of a plurality of sub-pixels at a first viewing angle are acquired.

In act 402, a first mapping relationship between a first distance and a chief ray angle is acquired, wherein the first distance is a distance from a sub-pixel to a center of a display area of the display panel, the chief ray angle is an included angle between a direction in which the luminous intensity of the sub-pixel is greatest and a direction perpendicular to a light emitting direction of the display panel.

In act 403, luminances of a single sub-pixel at a plurality of viewing angles are acquired, and a second mapping relationship between the viewing angle and the luminance of the single sub-pixel is obtained.

In act 404, second luminances of the plurality of sub-pixels at chief ray angles are determined according to the acquired first luminances, the first mapping relationship, and the second mapping relationship, and a sub-pixel whose second luminance is lower than a luminance threshold is marked as a dark spot.

According to the dark spot detection method for the display panel provided by the embodiment of the present disclosure, the second luminances of the plurality of sub-pixels at the chief ray angles are determined according to the first luminances of the plurality of sub-pixels at the first viewing angle, the first mapping relationship between the first distance and the chief ray angle, and the second mapping relationship between the viewing angle and the luminance of the single sub-pixel, and the sub-pixel whose second luminance is lower than the luminance threshold is marked as the dark spot, thereby accurately outputting the number and coordinates of sub-pixel dark spots, ensuring the accuracy of the dark spot detection of the display panel, and greatly improving detection efficiency. In addition, the present disclosure is applicable to dark spot detection of a display panel with a chief ray angle, can exclude the influence of temperature on luminance of the sub-pixel, and can detect the sub-pixel dark spot caused by various reasons, including low efficiency of a light emitting unit.

As shown in FIGS. 4B and 4C, the display panel of the present disclosure may include a drive backplane 1 and a plurality of light emitting modules 01. The drive backplane 1 has a pixel area 10, and the pixel area 10 includes a central area 101 and n offset areas 102 sequentially surrounding the central area 101, wherein n is a positive integer. A length of the pixel area 10 in the row direction is W, and a length of the pixel area 10 in the column direction is L.

The plurality of light emitting modules 01 are provided on a side of the drive backplane 1 and distributed in the central area 101 and the offset areas 102. One light emitting module 01 includes a plurality of light emitting units 011, and one light emitting unit 011 includes a light emitting device 0111 and a converging lens 0112 distributed along a direction away from the drive backplane 1.

In any one of the light emitting units 011 in the offset area 102, a center of an orthographic projection of the light emitting device 0111 on the drive backplane 1 is located on a side of a center of an orthographic projection of the converging lens 0112 on the drive backplane 1 away from the center area 101, and a distance between the center of the orthographic projection of the light emitting device 0111 on the drive backplane 1 and the center of the orthographic projection of the converging lens 0112 on the drive backplane 1 is an offset of the light emitting unit 011. An extension direction of a line between the center of the orthographic projection of the light emitting device 0111 on the drive backplane 1 and the center of the orthographic projection of the converging lens 0112 on the drive backplane 1 is an offset direction of the light emitting device 0111.

The offsets of the light emitting units 011 in the same offset area 102 are the same, and the offset directions of the light emitting units 011 of the same light emitting module 01 are the same.

The offset of the light emitting unit 011 in the central area 101 is zero. The offset of the light emitting unit 011 in any offset area 102 is greater than the offset of the light emitting unit 011 in the central area 101, and the offsets of the light emitting units 011 in various offset areas 102 increase in a direction away from the central area 101.

The sizes of the chief ray angles of the light emitting units 011 in the same offset area 102 are the same, and the chief ray angles of the light emitting units 011 in the different offset areas 102 increase in the direction away from the center area 101, thereby increasing a light emitting range of the display panel, so as to match the light emitting range of the display panel with an optical path assembly, and improve the uniformity of the luminance of the image presented by the near-eye display device.

As shown in FIG. 4B and FIG. 4C, the drive backplane 1 of the display panel may further include a peripheral area 11 located outside the pixel area 10, and the peripheral area 11 may be an annular area disposed around the pixel area 10. The drive backplane 1 is configured to form a drive circuit for driving various light emitting devices 0111 to emit light, and the drive circuit may include a pixel circuit and a peripheral circuit.

The quantity of the pixel circuits and the quantity of the light emitting devices 0111 may both be a plurality, and the pixel circuits may be located in the pixel area 10. The pixel circuit may be 2T1C, 4T2C, 6T1C, or 7T1C pixel circuit, as long as the light emitting device 0111 can be driven by the pixel circuit to emit light, and the structure thereof is not specifically limited herein. The quantity of pixel circuits may be the same as the quantity of light emitting devices 0111 and the pixel circuits are connected to the light emitting devices 0111 in a one-to-one correspondence to control various light emitting devices 0111 to emit light respectively. Herein, nTmC means that one pixel circuit includes n transistors (represented by the letter “T”) and m capacitors (represented by the letter “C”). Of course, the same pixel circuit may also drive a plurality of light emitting devices 0111.

The peripheral circuit is located in the peripheral area 11 and is connected to the pixel circuit. The peripheral circuit may include at least one of a light emitting control circuit, a gate drive circuit, a source drive circuit and a power supply circuit, and of course may also include other circuits as long as the light emitting device 0111 can be driven to emit light through the pixel circuit.

In some implementations of the present disclosure, the drive backplane 1 may include a substrate and at least one wiring layer disposed on the substrate, wherein the substrate may be a silicon substrate, the drive circuit may be formed on the silicon substrate with a semiconductor process, for example, both the pixel circuit and the peripheral circuit may include a plurality of transistors, and a well region may be formed in the silicon substrate with a doping process, the well region has two doped areas spaced apart. And taking a well region as an example, a gate is provided on one side of the drive backplane 1, that is, an orthographic projection of the gate on the substrate is located between the two doped areas. At least one wiring layer is connected to a doped area, and one wiring layer may include a source and a drain connected to the two doped areas of the same well region. The transistors are connected through various wiring layers to form a drive circuit. The specific connection lines and wiring pattern depend on the circuit structure, and there is no special restriction here.

The wiring layer may be covered with a planarization layer of which material may be silicon oxide, silicon nitride oxide or silicon nitride, which may be formed layer by layer through a plurality of deposition and polishing processes. The planarization layer may be formed by stacking a plurality of insulating film layers.

As shown in FIGS. 4B and 4C, a light emitting functional layer 2 may be provided on the drive backplane 1, and the light emitting functional layer 2 may include a plurality of light emitting devices 0111. Various light emitting devices 0111 are distributed on one side of the drive backplane 1 in an array, for example, various light emitting devices 0111 are provided on a surface of the planarization layer away from the substrate. Each light emitting device 0111 may include a first electrode 21, a second electrode 24, and a light emitting layer 23 located between the first electrode 21 and the second electrode 24, both the first electrode 21 and the second electrode 24 may be connected to the wiring layer. Meanwhile, the peripheral circuit may also include a power supply circuit connected to the second electrode 24 for inputting a power supply signal to the second electrode 24. The peripheral circuit may control the light emitting device 0111 to emit light by inputting a drive signal to the first electrode 21 through the pixel circuit and inputting a power supply signal to the second electrode 24.

In order to achieve color display, each light emitting device 0111 may be made to emit light of the same color, in conjunction with a color filter layer 4 disposed on the side of the second electrode 24 away from the substrate, to achieve the color display. Embodiments of the present disclosure take this color display solution as an example to explain. Of course, various light emitting devices may be made to emit light independently, and the light emitting colors of different light emitting devices 0111 may be different.

In some implementations of the present disclosure, as shown in FIG. 4B, a plurality of light emitting devices 0111 may be formed through a first electrode layer, a pixel definition layer 22, a light emitting layer 23, and a second electrode 24.

The first electrode layer is arranged on a surface of the planarization layer away from the substrate. The first electrode layer may include a plurality of first electrodes 21 spaced apart, and an orthographic projection of each first electrode 21 on the substrate is located in the pixel area 10, and is connected to the pixel circuit, and one first electrode 21 is connected to one pixel circuit.

As shown in FIG. 4B, the pixel definition layer 22 covers the planarization layer and exposes various first electrodes 21. Specifically, the pixel definition layer 22 is provided with openings 221 that expose the first electrodes 21. A range of each light emitting device 0111 can be defined through the pixel definition layer 22 and the opening 221 thereof. The light emitting range of the light emitting device 0111 is also defined by the opening 221, and the boundary of the opening 221 the boundary of the light emitting device 0111. A direction in which the luminous intensity of the light emitting device 0111 is greatest may be a direction perpendicular to the first electrode 21 and passing through the center of the opening 221. The material of the pixel defining layer 22 may be an insulating material such as silicon oxide or silicon nitride and is not specifically limited here.

As shown in FIG. 4B, the light emitting layer 23 covers the pixel defining layer 22 and the first electrode 21, and the light emitting layer 23 is located in an opening 221, and an area stacked with the first electrode are used to form the light emitting device 0111, that is, various light emitting devices 0111 may share the same light emitting layer 23, that is, portions of the light emitting layer 23 located in different openings 221 belong to different light emitting devices 0111. In addition, since various light emitting devices 0111 share the light emitting layer 23, the light emitting colors of different light emitting devices 0111 are the same.

For example, the light emitting layer 23 may include a plurality of light emitting sublayers sequentially connected in series in a direction away from the substrate, and at least one light emitting sublayer is connected in series with an adjacent light emitting sublayer through a charge generation layer. When electrical signals are applied to the first electrode 21 and the second electrode 24, each of the light emitting sublayers can emit light, and different light emitting sublayers can be used to emit light of different colors.

As shown in FIG. 4B, the second electrode 24 covers the light emitting layer 23, and an orthographic projection of the second electrode 24 on the substrate may cover the pixel area 10 and extend into the peripheral area 11. Various light emitting devices 0111 may share the same second electrode 24. When a voltage difference between the second electrode 24 and the first electrode 21 reaches a voltage difference that enables the light emitting layer 23 to emit light, the light emitting layer 23 can emit light. Therefore, the light emitting layer 23 may be controlled to emit light through controlling the voltage of the power supply signal input to the second electrode 24 and the voltage of the drive signal input to the first electrode 21.

As shown in FIG. 4B, in some implementations of the present disclosure, the display panel of the present disclosure may also include an encapsulation layer 3 that may cover various light emitting devices 0111. For example, the encapsulation layer 3 is provided on a side of the second electrode 24 away from the substrate, and is located between the color filter layer 4 and the second electrode 24, for blocking the erosion of water and oxygen from the outside. The encapsulation layer 3 may be a monolayer or multilayer structure, for example, the encapsulation layer 3 may include a first encapsulation sublayer 31, a second encapsulation sublayer 32, and a third encapsulation sublayer 33 that are sequentially stacked along a direction away from the substrate. The materials of the first encapsulation sublayer 31 and the second encapsulation sublayer 32 may be inorganic insulating materials such as silicon nitride (SiN) and alumina (AL₂O₃). For example, the material of the first encapsulation sublayer 31 is silicon nitride, the material of the second encapsulation sublayer 32 is alumina, and the material of the third encapsulation sublayer 33 may be an organic material such as Parylene.

As shown in FIG. 4B, in order to realize color display, the display panel may also include a color filter layer 4. The color filter layer 4 may be provided on a side of the second electrode 24 away from the substrate, and includes a plurality of filter portions 0113, various light emitting devices 0111 and various the filter portions 0113 are disposed in a one-to-one correspondence in a direction perpendicular to the substrate, that is, an orthographic projection of one filter portion 0113 on the planarization layer at least partially overlaps with the first electrode 21. Various filter portions 0113 include at least three color filter portions 0113, for example, a filter portion 0113 capable of transmitting red light, a filter portion 0113 capable of transmitting green light, and a filter portion 0113 capable of transmitting blue light. The light emitted by various light emitting devices 0111 is filtered by the light filtering portion 0113 to obtain single color light of different colors, thereby realizing color display.

A shape of an orthographic projection of the filter portion 0113 on the substrate may be larger than the opening 221 of the pixel definition layer 22, and orthographic projections of various openings 221 on the substrate are located in one-to-one correspondence within orthographic projections of various filter portions 0113 on the substrate.

As shown in FIG. 4B, the color filter layer 4 may further include a shading portion separating the filter portions 0113, the shading portion is opaque to light, and shades an area between the two light emitting devices 0111. The filter portion 0113 may be directly spaced from the filter portion 0113 using a light blocking material. Alternatively, in some implementations of the present disclosure, adjacent light filter portions 0113 may be stacked in a region corresponding to the region between adjacent light emitting devices 0111, and the colors of light transmitted by the two filter portions are different, so that the stacked region is opaque.

In addition, in some implementations of the present disclosure, the color filter layer 4 may further include a transparent portion in order to improve the luminance of the image on the basis that the light emitting layer 23 emits white light. In the direction perpendicular to the substrate, one transparent portion may be disposed opposite to one light emitting unit 011, so that the color filter layer 4 may also transmit white light, and the luminance can be increased through white light.

A converging layer may be provided on one side of the color filter layer 4 that is away from the drive backplane 1, and the converging layer includes a plurality of converging lenses 0112 distributed in an array, various converging lenses 0112 are provided in a direction perpendicular to the drive backplane 1 in one-to-one correspondence with various light emitting devices 0111 and, of course, with various filter portions 0113. Light emitted by any light emitting device 0111 may pass through its corresponding filter portion 0113 and the converging lens 0112, and the converging lens 0112 may converge the light to a specified range to improve the luminance of the display panel.

As shown in FIG. 4B, the structure of the converging lens 0112 is not specifically limited here, as long as the converging function described above can be realized. For example, the converging lens 0112 may be a spheroidal cap structure that bulges in a direction away from the drive backplane 1, and its surface may be enclosed by a plane and a spherical crown.

Based on the structure of the display panel described above, as shown in FIG. 4B, a plurality of light emitting modules 01 may be divided in the display panel, various light emitting modules 01 are located on a side of the drive backplane 1, and may include a plurality of light emitting units 011, the light emitting units may be distributed in an array along row directions and column directions. Each light emitting unit 011 may include one light emitting device 0111 and its corresponding converging lens 0112, and a filter portion 0113 located between the light emitting device 0111 and the converging lens 0112. The light emitting range of the light emitting unit 011 is defined by the light emitting device 0111 and the converging lens 0112, and the color of the light emitting is defined by the filter portion 0113. One light emitting module 01 may be regarded as one pixel, and each light emitting unit 011 contained in the pixel may be regarded as a sub-pixel.

In some implementations of the present disclosure, one light emitting module 01 may include three light emitting units 011 with different light emitting colors, such as a red light emitting unit 011, a green light emitting unit 011, and a blue light emitting unit 011.

As shown in FIG. 4B, in any light emitting unit 011, a distance between a center of an orthographic projection of the light emitting device 0111 on the drive backplane 1 and a center of an orthographic projection of its converging lens 0112 on the drive backplane 1 may be defined as an offset ΔS of the light emitting unit 011. An extension direction of a line between the center of the orthographic projection of the light emitting device 0111 on the drive backplane 1 and the center of the orthographic projection of the converging lens 0112 on the drive backplane 1 is an offset direction of the light emitting device 0111. As shown in FIGS. 4D and 4E, an angle between a direction in which the luminous intensity of the light emitting unit 011 is greatest and a direction perpendicular to the drive backplane 1 is a chief ray angle.

As shown in FIGS. 4D and 4E, a light emitting range of any light emitting unit 011 is a chief ray angle±a designated angle γ, for example, the designated angle γ may be 15°, of course, the designated angle may be 20° or 10° etc., depending on the light emitting range of the light emitting device 0111 and the sizes of the filter portion 0113 and the converging lens 0112, which are not specifically limited here.

The offsets of the light emitting units 011 in the same offset area 102 are the same, so that the sizes of the chief ray angles of the light emitting units 011 in the same offset area 102 are the same, but the offset directions may be radially distributed in circumferential directions around the central area 101. The offset direction of each light emitting unit 011 of the same light emitting module 01 is the same, so as to avoid affecting the screen display for the chief ray angle of each light emitting unit 011 of the same light emitting module 01 differ.

As shown in FIGS. 4B to 4E, the offset of the light emitting unit 011 in the central area 101 is zero, that is, the chief ray angle of the light emitting unit 011 in the central area 101 is zero, and the direction in which luminance of the light emitting unit 011 is greatest in the central area 101 is perpendicular to the drive backplane 1. The offset of the light emitting unit 011 in any offset area 102 is greater than the offset of the light emitting unit 011 in the central area 101, and the offsets of the light emitting units 011 in the different offset areas 102 increase in the direction away from the central area 101, so that the chief ray angles increase in the direction away from the central area 101, thereby increasing the light emitting range.

Since the chief ray angles corresponding to various offset areas 102 are different, the traditional dark spot detection method cannot effectively identify the dark spots. The dark spot detection method of the embodiment of the present disclosure determines the second luminances of the plurality of sub-pixels at the chief ray angle according to the first luminances of the plurality of sub-pixels at the first viewing angle, the first mapping relationship between the first distance and the chief ray angle, and the second mapping relationship between the viewing angle and the luminance of the single sub-pixel, and marks the sub-pixel whose second luminance is lower than the luminance threshold as the dark spot, thereby accurately outputting the quantity and coordinates of sub-pixel dark spots, ensuring the accuracy of the dark spot detection of the display panel, and greatly improving detection efficiency.

In some exemplary embodiments, the display panel includes a plurality of first sub-pixels emitting light of a first color, a plurality of second sub-pixels emitting light of a second color, and a plurality of third sub-pixels emitting light of a third color, and the acquiring the first luminances of the plurality of sub-pixels at the first viewing angle includes: enabling the display panel to display a solid color image of the first color, and testing first luminances of all first sub-pixels at the first viewing angle in a one-time whole-surface test using a first test device.

In some exemplary embodiments, the acquiring the first luminances of the plurality of sub-pixels at the first viewing angle further includes: enabling the display panel to display a solid color image of the second color, and testing first luminances of all second sub-pixels at the first viewing angle in a one-time whole-surface test using the first test device.

In some exemplary embodiments, the acquiring the first luminances of the plurality of sub-pixels at the first viewing angle further includes: enabling the display panel to display a solid color image of the third color, and testing first luminances of all third sub-pixels at the first viewing angle in a one-time whole-surface test using the first test device.

In the dark spot detection method according to the embodiment of the present disclosure, sub-pixels of each color are detected respectively. Each time a test is performed, the display panel is made to display a solid color image P, for example, the solid color image P may be an R255 image, a G255 image, or a B255 image. The first test device is used to test first luminance information L₀_{_{(i,j)}} of all the light emitting sub-pixels (the first sub-pixels, the second sub-pixels or the third sub-pixels) at the first viewing angle in a one-time whole-surface test. The center of the display area of the display panel is taken as the coordinate origin, and i and j are the X-axis coordinate and Y-axis coordinate of the sub-pixel, respectively, −n₁≤i≤n₂, −m₁≤j≤m₂, n₁+n₂+1 is the quantity of sub-pixel columns, m₁+m₂+1 is the quantity of sub-pixel rows, n₁, n₂, m₁ and m₂ are all natural numbers greater than or equal to 1.

In some exemplary embodiments, the first color, the second color, and the third color may be any one of three colors, that is, red, green, and blue, respectively. However, the embodiments of the present disclosure are not limited thereto, and the display panel may also include four or sub-pixels of other numbers of different colors. For example, the display panel may include a plurality of red sub-pixels emitting red light, a plurality of green sub-pixels emitting green light, a plurality of blue sub-pixels emitting blue light, and a plurality of white sub-pixels emitting white light.

In some exemplary embodiments, the first viewing angle may be a 0° viewing angle. However, the embodiments of the present disclosure are not limited thereto.

In the embodiment of the present disclosure, when a line connecting the light emitted from the sub-pixel to the human eye or the test device is perpendicular to a light emitting surface of the display panel, the viewing angle of the human eye or the test device is a 0° viewing angle. When the line connecting the light emitted from the sub-pixel to the human eye or the test device is not perpendicular to the light emitting surface of the display panel, the human eye or the test device has a viewing angle between 0° and 90° or between −90° and 0°, for example, the viewing angle of human eye or the test device may be a 10° viewing angle.

In some exemplary embodiments, the first test device may be a surface photo luminance meter or an imaging luminance meter or the like.

Luminance refers to luminance that the eyes feel when a person sees a light source. The symbol of luminance is L, the unit thereof is nit, 1 nit=1 candela/m² (cd/m²), where cd is the unit of light intensity. The surface photo luminance meter uses a surface array Charge Coupled Device (CCD) as a light detector. It only needs to sample once to measure the luminance of millions of points in a plane at the same time, which is equivalent to millions of point luminance meters running at the same time.

In some exemplary embodiments, the first test device satisfies the following measurement conditions:

$$0.01 < {k}_{1} a \times Nx / f < 0.1 ;$$

$$0.01 < {k}_{2} b \times Ny / f < 0.1 ;$$

$${k}_{1} = nx / Nx ; {k}_{2} = ny / Ny .$$

Herein a is a length of a light emitting unit in a sub-pixel along a first direction X, b is a length of the light emitting unit in the sub-pixel along a second direction Y, Nx is the quantity of light emitting units in the display panel along the first direction, Ny is the quantity of light emitting units in the display panel along the second direction, f is a lens focal length of the first test device, and nx is the quantity of light emitting units in an effective sampling diameter range of the first test device in a plane perpendicular to the plane where the display panel is located, passing through a center line of the first test device, and parallel to the first direction; ny is the quantity of light emitting units in an effective sampling diameter range of the first test device in a plane perpendicular to the plane where the display panel is located, passing through the center line of the first test device, and parallel to the second direction.

As shown in FIG. 3, since the temperature of the display panel affects the display luminance, the luminance information acquired at different times may vary with the temperature. When the first test device meets the above measurement conditions, the first test device can implement the whole-surface acquisition of the display panel through one-time acquisition, so that the influence of the temperature change of the display panel on the test result can be excluded.

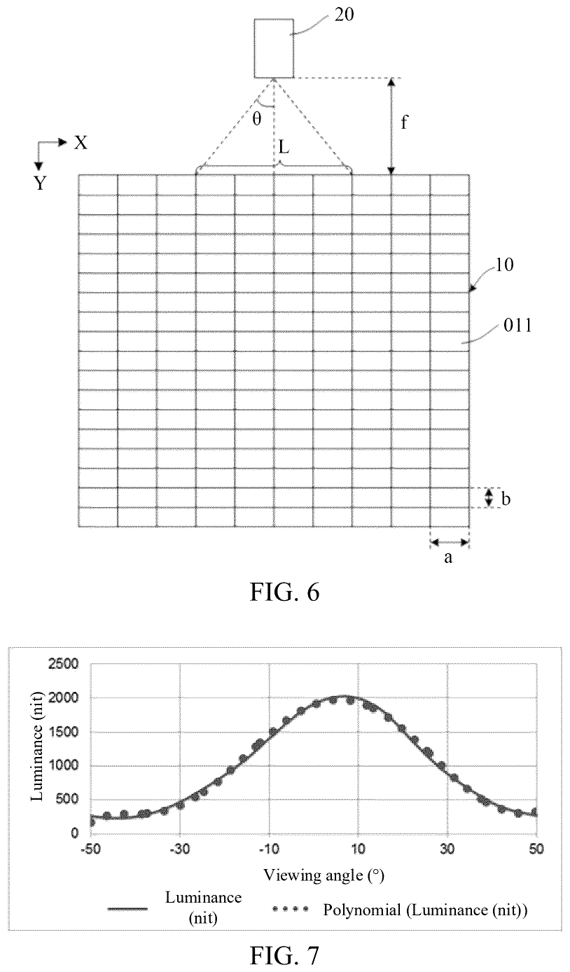

FIG. 5 and FIG. 6 are schematic diagrams showing first luminance information acquisition of a display panel according to an exemplary embodiment of the present disclosure. As shown in FIG. 5 and FIG. 6, the first test device 20 may be located at a position of a light emitting side of the display panel (for example, it may be a center position in front of the light emitting side of the display panel) in order to acquire the luminance of the display panel. The display area of the display panel may include a plurality of sub-pixels, and each of the sub-pixels includes one light emitting unit 011. The light emitting unit 011 may, for example, be rectangular, however, the embodiments of the present disclosure are not limited thereto. The length of the light emitting unit 011 along the first direction X may be a, and the length along the second direction Y may be b. The quantity of light emitting units 011 along the first direction X may be Nx, and the quantity of light emitting units 011 along the second direction Y may be Ny in the display area of the display panel. For example, the attribute information of the light emitting units 011 of the display panel may at least include the length a of the light emitting unit 011 along the first direction X, the length b of the light emitting unit 011 along the second direction Y, the quantity of light emitting units Nx in the display area along the first direction X, and the quantity of light emitting units Ny in the display area along the second direction Y.

As shown in FIG. 6, taking the surface photo luminance meter as an example, it is assumed that the lens focal length of the surface photo luminance meter is f. In a plane perpendicular to the plane where the display panel is located and passing through a centerline of the surface photo luminance meter, the effective sampling diameter of the surface photo luminance meter may be L. In a plane perpendicular to the plane where the display panel is located, passing through the center line of the surface photo luminance meter, and parallel to the first direction X, the quantity of light emitting units within the effective sampling diameter range may be nx. In a plane perpendicular to the plane where the display panel is located, passing through the center line of the surface photo luminance meter, and parallel to the second direction Y, the quantity of light emitting units within the effective sampling diameter range may be ny. The sampling viewing angle of the surface photo luminance meter may be θ. In embodiments of the present disclosure, the sampling viewing angle is defined as an included angle between the sampling edge line of sight and the centerline of the test device. In this example, the acquisition parameters of the first test device 20 may at least include a lens focal length f, a sampling angle θ, and an effective sampling diameter L.

The first test device 20 satisfies the following one-time whole-surface acquisition conditions for the display panel:

$$0.01 < {k}_{1} a \times Nx / f < 0.1 ;$$

$$0.01 < {k}_{2} b \times Ny / f < 0.1 .$$

Herein k₁=nx/Nx; k₂=ny/Ny. 0<k₁≤1, 0<k₂≤1, exemplarily, k₁ and k₂ may be greater than 0.3. When the first test device 20 satisfies the one-time whole-surface acquisition condition for the display panel to be detected, the first test device 20 can perform luminance acquisition excluding the influence of a temperature factor on the luminance values of all light emitting units of the display panel. In this way, the dark spot detection of the display panel by using the acquired first luminance information is conducive to improving the accuracy of the detection and evaluation result and the evaluation efficiency.

In some other exemplary embodiments, the one-time whole-surface acquisition condition may also include: the sampling angle θ of the first test device is greater than or equal to A degrees, wherein A is between 7 and 10.

In this example, when the one-time whole-surface acquisition condition is satisfied, the first test device 20 may perform luminance acquisition which simultaneously excluding the influences of viewing angle and temperature factors on the luminance value of the display panel to, so as to be beneficial to improving the accuracy of the detection evaluation result and the evaluation efficiency. When the tested sub-pixel is within a range of the sampling viewing angle θ of the surface photo luminance meter, the surface photo luminance meter may convert the luminance at the actual viewing angle to the luminance at the 0° viewing angle regardless of whether the actual viewing angle of the tested sub-pixel by the surface photo luminance meter is 0°.

Table 1 provides an example of attribute information and acquisition parameters of light emitting units of a plurality of categories of display panels. As shown in Table 1, display panel 1 is a small-sized (e.g., 0.39 inches, resolution is 1920×1080) display panel, display panel 2 is a large-sized (e.g., 6.0 inches, resolution is 2560×1600) display panel, display panel 3 is a large-sized (e.g., 6.0 inches, resolution is 1280×720) display panel, display panel 4 is a large-sized (e.g., 5.0 inches, resolution is 1920×1080) display panel, display panel 5 is a large-sized (e.g., 7.0 inches, resolution is 1024×600) display panel, and display panel 6 is a large-sized (e.g., 9.7 inches, resolution is 2048×1536) display panel.

TABLE 1

| Category | A (μm) | b (μm) | f (mm) | θ (°) | L (mm) | nx | ny |
|---|---|---|---|---|---|---|---|
| Display | 4.5 | 4.5 | 143 | 8 | 40 | 8888 | 8888 |
| panel 1 | | | | | | | |
| Display | 51 | 51 | 143 | 8 | 40 | 784 | 784 |
| panel 2 | | | | | | | |
| Display | 103 | 103 | 143 | 8 | 40 | 388 | 388 |
| panel 3 | | | | | | | |
| Display | 57 | 57 | 143 | 8 | 40 | 701 | 701 |
| Panel 4 | | | | | | | |
| Display | 117 | 117 | 143 | 8 | 40 | 341 | 341 |
| panel 5 | | | | | | | |
| Display | 96 | 96 | 143 | 8 | 40 | 416 | 416 |
| panel 6 | | | | | | | |

As can be seen from Table 1, the display panel 1 is a small-sized display panel (e.g., a silicon-based OLED), and the display panels 2 to 6 are large-sized display panels (e.g., a glass-based OLED or a PI-based OLED). For a small-sized display panel, when the one-time whole-surface acquisition condition is met (due to the small size, the one-time whole-surface acquisition condition can usually be met), the luminance value of all light emitting units of the display panel may be acquired in a single whole-surface mode by using the first test device, so as to exclude the influence of temperature on the dark spot detection result of the display panel. For a large-sized display panel, since the first test device only acquires the luminance values of the light emitting units in a part of the display area of the display panel at a single time, the luminance values of the light emitting units beyond the acquisition range will be distorted, and a plurality of acquisitions are required to realize whole-surface acquisition, and the influence of temperature on the luminance detection result cannot be excluded in the process of a plurality of acquisitions.

In some exemplary embodiments, acquiring the first mapping relationship between the first distance and the chief ray angle includes: testing chief ray angles of N1 sub-pixels at different first distances through the second test device, wherein N1 is a natural number greater than 2, and obtaining the first mapping relationship between the first distance and the chief ray angle by performing formula fitting.

In the embodiment of the present disclosure, after the mapping data of N1 groups between the first distances and the chief ray angles are obtained by testing of the second test device, the first mapping relationship between the first distance and the chief ray angle may be obtained through formula fitting by software such as Matlab or Excel. And then the chief ray angle corresponding to a sub-pixel at any first distance may be obtained according to the first mapping relationship. When the first mapping relationship between the first distance and the chief ray angle is acquired, the N1 test points need to cover at least the center pixel point of the display area and pixel points at utmost edges of the display area, so as to have statistical significance.

In some exemplary embodiments, when the formula fitting is performed on the first mapping relationship between the first distance and the chief ray angle, the curve corresponding to the first mapping relationship between the two adjacent first distances is a straight line.

For example, the data of the adjacent two first distances and the chief ray angles are (d1, CRA1), (d2, CRA2), respectively, then a slope of the straight line fitted between the two first distances is (CRA2−CRA1)//(d2−d1). In this way, a curve formed by splicing a plurality of straight line segments is fitted from the coordinate origin (that is, the center of the display area of the display panel) to the edge of the display panel, as shown in FIG. 2, wherein the first mapping relationship curve corresponding to the chief ray angle of the micro-lens is set as a straight line between two adjacent sampling points.

In some exemplary embodiments, the second test device may be a spot luminance meter.

In some exemplary embodiments, the N1 sub-pixels are equidistant, and exemplarily, a chief ray angle corresponding to one sub-pixel may be tested every 0.5 mm or 1 mm.

In act 402, when the display panel displays the solid color picture P, the chief ray angles CRA_{(i,j)} at different first distances are tested by using the spot luminance meter, and the test results are shown in the curve of the chief ray angles of the micro-lens in FIG. 2. The calculation expression for the first distance H_{(i,j)} at sub-pixel (i, j) and the expression for the CRA_{(i,j)} of the chief ray angle at the first distance H_{(i,j)} obtained from the fitting are, respectively:

$${H}_{( i , j )} = \sqrt{{( \vert i \vert )}^{2} {a}^{2} + {( \vert j \vert )}^{2} {b}^{2}} \qquad ( 1 )$$

$${CRA}_{( i , j )} = - 0.0004 {H}_{{( i , j )}^{6}} + 0.007 {H}_{{( i , j )}^{5}} - 0.0175 {H}_{{( i , j )}^{4}} - 0.1632 {H}_{{( i , j )}^{3}} + 0.6798 {H}_{{( i , j )}^{2}} + 1.4375 {H}_{( i , j )} + 0.0 \; 082 \qquad ( 2 )$$

In expressions (1) and (2), the center of the display area of the display panel is taken as the coordinate origin, i, j are coordinates of the sub-pixel, a, b are the length and width of the sub-pixel, −n₁≤i≤n₂, −m₁≤j≤m₂, n₁+n₂+1 is the quantity of sub-pixel columns, m₁+m₂+1 is the quantity of sub-pixel rows, n₁, n₂, m₁ and m₂ are all natural numbers greater than or equal to 1. In the embodiment of the present disclosure, the formula (2) obtained through the above fitting is only an example, and the formula (2) obtained through fitting in different display panels may not be the same.

In some exemplary embodiments, acquiring luminances of a single sub-pixel at a plurality of viewing angles, and obtaining a second mapping relationship between the viewing angle and the luminance of the single sub-pixel includes: testing luminance values of a single sub-pixel at N2 different viewing angles by using a second test device, wherein N2 is a natural number greater than 2, and a maximum viewing angle in the N2 different viewing angles is greater than or equal to θ₁°, a minimum viewing angle is less than or equal to −θ₂°, where θ₁ equals to a maximum chief ray angle value in the chief ray angles of all sub-pixels, −θ₂ equals to a minimum chief ray angle value in the chief ray angles of all the sub-pixels; and obtaining a second mapping formula of the viewing angle and luminance of the single sub-pixel by performing formula fitting.

In the embodiment of the present disclosure, N2 different viewing angles need to meet a certain test viewing angle range, that is, (−θ₂°, θ₁°), in order to have a better curve/formula fitting effect. In actual use, the range of values for θ₁ and θ₂ may be determined based on the maximum chief ray angle and minimum chief ray angle values among the chief ray angles of all sub-pixels of the display panel. Exemplarily, assuming that the maximum chief ray angle value and the minimum chief ray angle value are 40° and −40°, respectively, then θ₁ may take a value greater than or equal to 40, and −θ₂ may take a value less than or equal to −40, thereby ensuring the validity of the fitted curve/formula.

In some exemplary embodiments, a single sub-pixel (i₀, j₀) may be located at the central positon of the display area.

In this example, when the display panel displays a solid color image P, a spot luminance meter is used to test the luminance values of a single sub-pixel at different viewing angles, −n₁≤i₀≤n₂, −m₁≤j₀≤m₂. Exemplarily, i₀=0, j₀=0. Thus, the accuracy of dark spot detection of the display panel can be ensured.

In this embodiment, the curve corresponding to the second mapping relationship between the viewing angle θ and the luminance L of a single sub-pixel is a curve L(θ, CRA₍ᵢ_{₀}_{,j}_{₀}₎) symmetric about the chief ray angle CRA₍ᵢ_{₀}_{,j}_{₀}₎, wherein −90°≤θ≤90°, the luminance curve L (θ, CRA₍ᵢ_{₀}_{,j}_{₀}₎) satisfies: the derivative of L is calculated with respect to θ, and the derivative at CRA₍ᵢ_{₀}_{,j}_{₀}₎ is equal to 0, that is,

$${L}^{′} ( {CRA}_{( {i}_{0} , {j}_{0} )} , {CRA}_{( {i}_{0} , {j}_{0} )} ) = {0}_{∘}$$

Exemplarily, FIG. 7 is a schematic diagram of a luminance curve of a single sub-pixel (i₀, j₀) of a display panel at different viewing angles according to an exemplary embodiment of the present disclosure. In FIG. 7, a plane where the viewing angle direction is located is a plane that passes through the center of the display area of the display panel and a point of sub-pixel (i₀, j₀) and is perpendicular to a light emitting surface of the display panel. As shown in FIG. 7, a luminance calculation expression of the single sub-pixel (i₀, j₀) obtained by fitting is as follows:

$${LV}_{α} = - 1 E - 07 {α}^{6} + 6 E - 06 {α}^{5} + 0.0009 {α}^{4} - 0.025 {α}^{3} - 2.1026 {α}^{2} + 26.112 α + 1897.3 \qquad ( 3 )$$

Herein α is a viewing angle of a single sub-pixel (i₀, j₀) at a half-image height; LV_{α} is a luminance value of the single sub-pixel (i₀, j₀) at α viewing angle at the half-image height, α is between −90° and 90°. In the embodiment of the present disclosure, the formula (3) obtained through the above fitting is only an example, and the formulas (3) obtained through fitting different display panels may not be the same.

In some exemplary embodiments, determining the second luminances of the plurality of sub-pixels at the chief ray angles according to the acquired first luminances, first mapping relationship, and second mapping relationship includes: determining luminance

$${LV}_{{CRA}_{( {i}_{0} , {j}_{0} )}}$$

of a sub-pixel (i₀, j₀) at a chief ray angle CRA₍ᵢ_{₀}_{,j}_{₀}₎; for the plurality of sub-pixels (i, j), performing the following operations respectively: determining a chief ray angle CRA_{(i,j)} of a sub-pixel (i, j) according to the first mapping relationship, and calculating luminance

$${LV}_{( {CRA}_{( {i}_{0} , {j}_{0} )} - {CRA}_{( i , j )} )}$$

corresponding to a difference of chief ray angles (CRA₍ᵢ_{₀}_{,j}_{₀}₎−CRA_{(i,j)}) according to the second mapping relationship; putting luminance L₀_{_{(i,j)}} of the sub-pixel (i, j) at 0° viewing angle, the luminance

$${LV}_{{CRA}_{( {i}_{0} , {j}_{0} )}}$$

of the sub-pixel (i₀, j₀) at the chief ray angle CRA₍ᵢ_{₀}_{,j}_{₀}₎, and the luminance

$${LV}_{( {CRA}_{( {i}_{0} , {j}_{0} )} - {CRA}_{( i , j )} )}$$

corresponding to the difference of chief ray angles (CRA₍ᵢ_{₀}_{,j}_{₀}₎−CRA_{(i,j)}) into the following formula:

$${L}_{{CRA}_{( i , j )}} = {L}_{{0}_{( i , j )}} \frac{{LV}_{{CRA}_{( {i}_{0} , {j}_{0} )}}}{{LV}_{( {CRA}_{( {i}_{0} , {j}_{0} )} - {CRA}_{( i , j )} )}} \qquad ( 4 )$$

to obtain second luminance L_{CRA}_{_{(i,j)}} of the sub-pixels (i, j) at the chief ray angle CRA_{(i,j)}, wherein −n₁≤i≤n₂, −m₁≤j≤m₂, n₁+n₂+1 is the quantity of sub-pixel columns, m₁+m₂+1 is the quantity of sub-pixel rows, n₁, n₂, m₁ and m₂ are all natural numbers greater than or equal to 1.

In some other exemplary embodiments, the determining the second luminances of the plurality of sub-pixels at the chief ray angle according to the acquired first luminances, first mapping relationship, and second mapping relationship includes: for a plurality of sub-pixels (i, j), performing the following operations respectively: determining a chief ray angle CRA_{(i,j)} of a sub-pixel (i, j) according to the first mapping relationship; obtaining a third mapping relationship between the viewing angle and the luminance at the sub-pixel (i, j) according to luminance L₀_{_{(i,j)}} an of the sub-pixel (i, j) at 0° viewing angle, the chief ray angle CRA_{(i,j)} of the sub-pixel (i, j) and the second mapping relationship between the viewing angle and the luminance at single sub-pixel (i₀, j₀), wherein a curve corresponding to the third mapping relationship is a curve symmetric about the chief ray angle CRA_{(i,j)}; and obtaining second luminance of the sub-pixel (i, j) at the chief ray angle CRA_{(i,j)} according to the third mapping relationship.

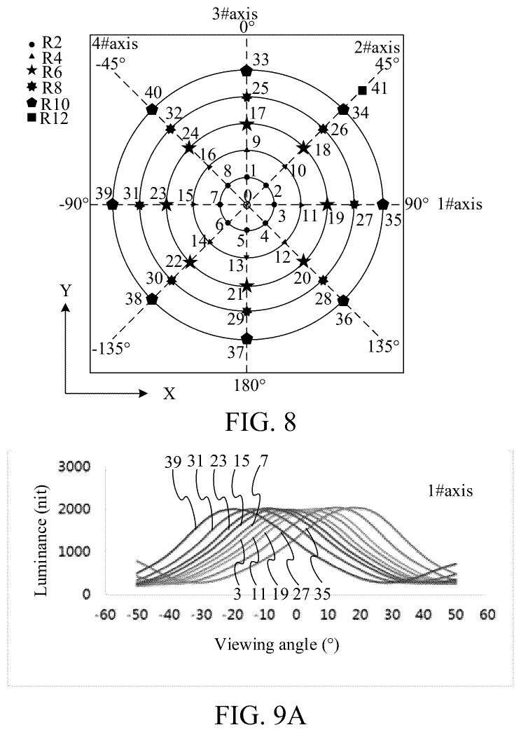

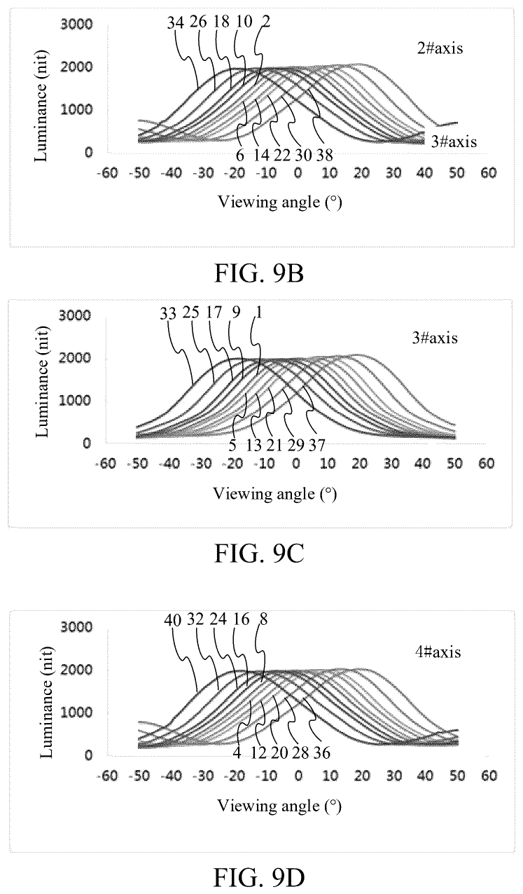

FIG. 8 is a schematic diagram of sub-pixel sampling positions at different first distances according to an exemplary embodiment of the present disclosure. As shown in FIG. 8, a total of 41 sub-pixel sampling points are provided, respectively located on 1 #axis to 4 #axis, and first distances of a plurality of sub-pixels on each concentric circle is the same, wherein R2 represents that the first distance is 2 mm, and the meanings of R4 to R12 are similar to that of R2. FIG. 9A to FIG. 9D are schematic diagrams of luminance variation curves, obtained from a test, of sub-pixels at different first distances in FIG. 8 with viewing angles. From FIG. 9A to FIG. 9D, it can be seen that the luminance curves of sub-pixels at different first distances with viewing angle are basically the same.

Accordingly, embodiments of the present disclosure provide a full-screen translation test way of CRA luminance viewing angle that can greatly improve detection efficiency, that is, according to the first luminance information of a sub-pixel (i, j) ((L₀_{_{(i,j)}}) at 0° viewing angle), luminance

$${LV}_{{CRA}_{( {i}_{0} , {j}_{0} )}}$$

of a sb-pixel (i₀, j₀) at the chief ray angle CRA₍ᵢ_{₀}_{,j}_{₀}₎ and luminance

$${LV}_{( {CRA}_{( {i}_{0} , {j}_{0} )} - {CRA}_{( i , j )} )}$$

corresponding to a difference of chief ray angles (CRA₍ᵢ_{₀}_{,j}_{₀}₎−CRA_{(i,j)}), luminance value L_{CRA}_{_{(i,j)}} of different sub-pixels (i, j) at the chief ray angle is obtained by calculation. Luminance values L_{CRA}_{_{(i,j)}} at chief ray angles of different sub-pixels (i, j) may be obtained by calculation, which greatly accelerates the detection efficiency.

In some exemplary embodiments, the luminance threshold includes any one of a preset luminance value, an average of luminances of a portion of the sub-pixels within a first display area, or an average of luminances of all sub-pixels within a first display area, wherein the first display area is an entire display screen or a portion of the entire display screen.

Exemplarily, the display panel may be divided into a plurality of display sub-regions, and dark spot detection is performed on each of the plurality of display sub-regions, in this case, the luminance threshold may be set as any one of the following: a luminance average of all red sub-pixels (or green sub-pixels or blue sub-pixels) within a single display sub-region, and a luminance average of all sub-pixels within a single display sub-region.

Exemplarily, after the second luminances of the plurality of sub-pixels at the chief ray angles are obtained, the luminance average L̅_̅{̅C̅R̅A̅}̅ of the plurality of sub-pixels at the chief ray angles is calculated, a sub-pixel whose second luminance is lower than the luminance average L̅_̅{̅C̅R̅A̅}̅ is marked as a dark spot, and finally the number and coordinate positions of sub-pixel dark spots of the display panel are counted and output.

According to the dark spot detection method provided by the embodiment of the present disclosure, the influence of temperature on the luminance of sub-pixels is excluded through a one-time whole-surface test; through the single-point luminance viewing angle test at a single sub-pixel, the accuracy of dark spot detection on the display panel is ensured; and through the full-screen translation test way of CRA luminance viewing angle, the detection efficiency is greatly improved.

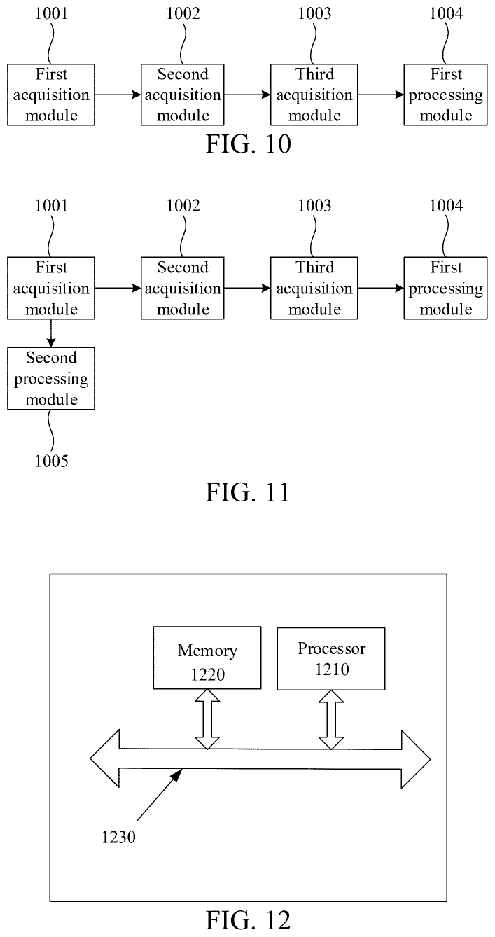

As shown in FIG. 10, an embodiment of the present disclosure also provides a dark spot detection apparatus for a display panel, including a first acquisition module 1001, a second acquisition module 1002, a third acquisition module 1003, and a first processing module 1004.

The first acquisition module 1001 is configured to acquire first luminances of a plurality of sub-pixels at a first viewing angle.

The second acquisition module 1002 is configured to acquire a first mapping relationship between a first distance and a chief ray angle, wherein the first distance is a distance from a sub-pixel to a center of a display area of a display panel, and the chief ray angle is an included angle between a direction in which luminous intensity of the sub-pixel is greatest and a direction perpendicular to the display panel.

The third acquiring module 1003 is configured to acquire luminances of a single sub-pixel at a plurality of viewing angles, and to obtain a second mapping relationship between a viewing angle and luminance of the single sub-pixel.

The first processing module 1004 is configured to determine second luminances of the plurality of sub-pixels at a chief ray angle according to the acquired first luminances, first mapping relationship, and second mapping relationship, and to mark a sub-pixel whose second luminance is lower than a luminance threshold as a dark spot.

In some exemplary embodiments, the first viewing angle is a 0° viewing angle.

In some exemplary embodiments, the second acquisition module acquires the first mapping relationship between the first distance and the chief ray angle, including: acquiring chief ray angles of sub-pixels at N1 different first distances by testing of a second test device, wherein N1 is a natural number greater than 2; and obtaining the first mapping relationship between the first distance and the chief ray angle by performing formula fitting.

In some exemplary embodiments, when formula fitting is performed on the first mapping relationship between the first distance and the chief ray angle, a curve corresponding to the first mapping relationship between the two adjacent first distances is a straight line.

In some exemplary embodiments, the third acquisition module 1003 acquires luminances of the single sub-pixel at the plurality of viewing angles to obtain the second mapping relationship between the viewing angle and the luminance of the single sub-pixel, including: acquiring luminance values of a single sub-pixel at N2 different viewing angles, which are obtained by testing of a second test device, wherein N2 is a natural number greater than 2, and a maximum viewing angle in the N2 different viewing angles is greater than or equal to θ₁°, a minimum viewing angle in the N2 different viewing angles is less than or equal to −θ₂°, where θ₁ equals to a maximum chief ray angle value in the chief ray angles of all sub-pixels, and −θ₂ equals to a minimum chief ray angle value in the chief ray angles of all sub-pixels; and obtaining the second mapping formula of the viewing angle and luminance of the single sub-pixel by performing formula fitting.

In this embodiment, a curve corresponding to the second mapping relationship between the viewing angle θ and the luminance L of a single sub-pixel is a curve L (θ,CRA₍ᵢ_{₀}_{,j}_{₀}₎) symmetric about symmetrical viewing angle CRA₍ᵢ_{₀}_{,j}_{₀}₎, wherein −90°≤θ≤90°, The luminance curve L(θ, CRA₍ᵢ_{₀}_{,j}_{₀}₎) satisfies: the derivative of L is calculated with respect to θ, and the derivative at CRA₍ᵢ_{₀}_{,j}_{₀}₎ equals to 0, that is, L′(CRA₍ᵢ_{₀}_{,j}_{₀}₎, CRA₍ᵢ_{₀}_{,j}_{₀}₎)=0.

In some exemplary embodiments, the first processing module 1003 determines the second luminances of the plurality of the sub-pixels at the chief ray angle according to the acquired first luminances, first mapping relationship, and second mapping relationship, including:
determining luminance

$${LV}_{{CRA}_{( {i}_{0} , {j}_{0} )}}$$

of a sub-pixel (i₀, j₀) at a chief ray angle CRA₍ᵢ_{₀}_{,j}_{₀}₎;
for a plurality of sub-pixels (i, j), performing the following operations respectively:
determining a chief ray angle CRA_{(i,j)} of a sub-pixel (i, j) according to the first mapping relationship; calculating luminance

$${LV}_{( {CRA}_{( {i}_{0} , {j}_{0} )} - {CRA}_{( i , j )} )}$$

corresponding to a difference of chief ray angles (CRA₍ᵢ_{₀}_{,j}_{₀}₎−CRA_{(i,j)}) according to the second mapping relationship; and
putting luminance L₀_{_{(i,j)}} of the sub-pixel (i, j) at 0° viewing angle, the luminance

$${LV}_{{CRA}_{( {i}_{0} , {j}_{0} )}}$$

of the sub-pixel (i₀, j₀) at the chief ray angle CRA₍ᵢ_{₀}_{,j}_{₀}₎, and the luminance

$${LV}_{( {CRA}_{( {i}_{0} , {j}_{0} )} - {CRA}_{( i , j )} )}$$

corresponding to the difference of chief ray angles (CRA₍ᵢ_{₀}_{,j}_{₀}₎−CRA_{(i,j)}) into the following formula

$${L}_{{CRA}_{( i , j )}} = {L}_{{0}_{( i , j )}} \frac{{LV}_{{CRA}_{( {i}_{0} , {j}_{0} )}}}{{LV}_{( {CRA}_{( {i}_{0} , {j}_{0} )} - {CRA}_{( i , j )} )}}$$

to obtain second luminance L_{CRA}_{_{(i,j)}} of the sub-pixel (i, j) at the chief ray angle CRA_{(i,j)};
wherein −n₁≤i≤n₂, −m₁≤j≤m₂, n₁+n₂+1 is the quantity of sub-pixel columns, m₁+m₂+1 is the quantity of sub-pixel rows, n₁, n₂, m₁ and m₂ are all natural numbers greater than or equal to 1.

According to the dark spot detection method of the embodiment of the present disclosure, through the calculation formula:

$${L}_{{CRA}_{( i , j )}} = {L}_{{0}_{( i , j )}} \frac{{LV}_{{CRA}_{( {i}_{0} , {j}_{0} )}}}{{LV}_{( {CRA}_{( {i}_{0} , {j}_{0} )} - {CRA}_{( i , j )} )}} ,$$

the second luminances of a plurality of sub-pixels at the chief ray angles are calculated, which can not only improve the detection efficiency, but also eliminate the luminance differences caused by process deviation.

In some other exemplary embodiments, the first processing module 1003 determines the second luminances of the plurality of sub-pixels at the chief ray angles according to the acquired first luminances, first mapping relationship, and second mapping relationship, including:
for a plurality of sub-pixels (i, j), performing the following operations respectively:
determining a chief ray angle CRA_{(i,j)} of a sub-pixel (i, j) according to the first mapping relationship;
obtaining a third mapping relationship between the viewing angle and the luminance at the sub-pixel (i, j) according to luminance L₀_{_{(i,j)}} of the sub-pixel (i, j) at 0° viewing angle, the chief ray angle CRA_{(i,j)} of the sub-pixel (i, j) and the second mapping relationship between the viewing angle and the luminance at single sub-pixel (i₀, j₀), wherein a curve corresponding to the third mapping relationship is a curve symmetric about the chief ray angle CRA_{(i,j)}; and
obtaining second luminance of the sub-pixel (i, j) at the chief ray angle CRA_{(i,j)} according to the third mapping relationship.

In some exemplary embodiments, the dark spot detection apparatus further includes a second processing module 1005 configured to determine whether a one-time whole-surface acquisition condition is satisfied according to attribute information of light emitting units of the display area of the display panel and an acquisition parameter of a first test device, wherein the first test device is configured to acquire first luminances of a plurality of sub-pixels at a first viewing angle.

FIG. 11 is a schematic diagram of another dark spot detection apparatus for a display panel according to an exemplary embodiment of the present disclosure. As shown in FIG. 11, the dark spot detection apparatus further includes a second processing module 1005. The second processing module 1005 determines whether a one-time whole-surface acquisition condition is satisfied according to attribute information of light emitting units of the display area of the display panel to be detected and an acquisition parameter of the first test device. Generally speaking, due to the small size of silicon-based OLED display panels, it can generally meet the one-time full-surface acquisition condition. When a non-silicon-based OLED display panel, such as a glass-based OLED or a PI-based OLED display panel, is tested through using the dark spot detection method of the present disclosure, whether the one-time whole-surface acquisition condition is satisfied may be determined according to the processing result of the second processing module 1005, to determine whether the detection result can exclude the influence of temperature on the luminance of the display panel.

Other descriptions of the dark spot detection apparatus of the present embodiment may refer to the description of the above embodiments and will not be repeated here.

An embodiment of the present disclosure further provides a dark spot detection apparatus for a display panel, including a memory and a processor connected to the memory. The memory is configured to store instructions, the processor is configured to perform the acts of the dark spot detection method for the display panel according to any embodiment of the present disclosure based on the instructions stored in the memory.

As shown in FIG. 12, in one example, the dark spot detection apparatus for the display panel may include a processor 1210, a memory 1220, and a bus system 1230. The processor 1210 and the memory 1220 are connected through the bus system 1230, the memory 1220 is configured to store instructions, and the processor 1210 is configured to execute instructions stored in the memory 1220. Specifically, the processor 1210 acquires first luminances of a plurality of sub-pixels at a first viewing angle, and acquires a first mapping relationship between a first distance and a chief ray angle, the first distance is a distance from a sub-pixel to a center of a display area of a display panel, the chief ray angle is an included angle between a direction in which the luminous intensity of the sub-pixel is greatest and a direction perpendicular to the display panel, and acquires luminances of a single sub-pixel at a plurality of viewing angles, and obtains a second mapping relationship between a viewing angle and luminance of the single sub-pixel, and determines second luminances of the plurality of sub-pixels at the chief ray angles according to the acquired first luminances, first mapping relationship, and second mapping relationship, and marks a sub-pixel whose second luminance is lower than a luminance threshold as a dark spot.

It should be understood that the processor 1210 may be a Central Processing Unit (CPU), or the processor 1210 may be another general-purpose processor, a Digital Signal Processor (DSP), an Application Specific Integrated Circuit (ASIC), a Field Programmable Gate Array (FPGA) or another programmable logic device, a discrete gate or a transistor logic device, a discrete hardware component, etc. The general-purpose processor may be a microprocessor, or the processor may be any conventional processor, etc.

The memory 1220 may include a read only memory and a random access memory, and provides instructions and data to the processor 1210. A portion of the memory 1220 may further include a non-volatile random access memory. For example, the memory 1220 may store information of a device type.

The bus system 1230 may also include a power bus, a control bus, a status signal bus, or the like in addition to a data bus. However, for clarity of illustration, various buses are all denoted as the bus system 1230 in FIG. 12.

In an implementation process, processing performed by a processing device may be completed through an integrated logic circuit of hardware in the processor 1210 or instructions in a form of software. That is, acts of the method in the embodiments of the present disclosure may be embodied as executed and completed by a hardware processor, or executed and completed by a combination of hardware in the processor and a software module. The software module may be located in a storage medium such as a random access memory, a flash memory, a read only memory, a programmable read only memory or an electrically erasable programmable memory, a register. The storage medium is located in the memory 1220, and the processor 1210 reads information in the memory 1220 and completes the acts of the above method in combination with its hardware. In order to avoid repetition, detailed description is not provided here.

An embodiment of the present disclosure further provides a computer-readable storage medium having stored thereon a computer program. When the program is executed by a processor, the dark spot detection method for a display panel according to any embodiment of the present disclosure is implemented. The dark spot detection method for the display panel driven by executing the executable instruction is basically the same as the dark spot detection method for the display panel provided in the above embodiments of the present disclosure, and will not be repeated here.

In some possible implementations, various aspects of the dark spot detection method for the display panel provided by the present disclosure may also be implemented as a form of a program product, which includes a program code, wherein when the program product runs on a computer device, the program code is used for enabling the computer device to perform acts in the dark spot detection method for the display panel according to various exemplary implementations of the present disclosure described above in the specification, for example, the computer device may perform the dark spot detection method for the display panel described in the embodiments of the present disclosure.

For the program product, any combination of one or more readable media may be used. A readable medium may be a readable signal medium or a readable storage medium. The readable storage medium may be, for example, but is not limited to, an electrical, magnetic, optical, electromagnetic, infrared, or semiconductor system, apparatus, or device, or a combination of any of the above. More specific examples (non-exhaustive list) of the readable storage medium include: an electrical connection with one or more wires, a portable disk, a hard disk, a Random Access Memory (RAM), a Read Only Memory (ROM), an Erasable Programmable Read Only Memory (EPROM or flash memory), an optical fiber, a portable Compact Disk Read Only Memory (CD-ROM), an optical storage device, a magnetic storage device, or any suitable combination of the above.

Those of ordinary skills in the art may understand that all or some of acts in the methods disclosed above, systems, functional modules or units in apparatuses may be implemented as software, firmware, hardware, and an appropriate combination thereof. In a hardware implementation, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile and non-volatile, and removable and irremovable media implemented in any method or technology for storing information (for example, a computer readable instruction, a data structure, a program module, or other data). The computer storage medium includes, but is not limited to, a RAM, a ROM, an Electrically Erasable Programmable Read Only Memory (EEPROM), a flash memory or another memory technology, a CD-ROM, a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skills in the art that the communication medium usually includes a computer readable instruction, a data structure, a program module, or other data in a modulated data signal of, such as, a carrier wave or another transmission mechanism, and may include any information delivery medium.

It should be noted that the above examples or embodiments are exemplary only and not restrictive. Therefore, the present disclosure is not limited to what is specifically shown and described herein. Various modifications, substitutions or omissions may be made in forms and details of implementations without departing from the scope of the present disclosure.

1. A dark spot detection method for a display panel, comprising:
acquiring first luminances of a plurality of sub-pixels at a first viewing angle;
acquiring a first mapping relationship between a first distance and a chief ray angle, wherein the first distance is a distance from a sub-pixel to a center of a display area of the display panel, the chief ray angle is an included angle between a direction in which a luminous intensity of the sub-pixel is greatest and a direction perpendicular to the display panel;
acquiring luminances of a single sub-pixel at a plurality of viewing angles, and obtaining a second mapping relationship between a viewing angle and luminance of the single sub-pixel; and
determining second luminances of the plurality of sub-pixels at chief ray angles according to the acquired first luminances, the acquired first mapping relationship, and the acquired second mapping relationship, and marking a sub-pixel whose second luminance is lower than a luminance threshold as a dark spot.

2. The dark spot detection method according to claim 1, wherein the display panel comprises a first sub-pixel emitting light of a first color, a second sub-pixel emitting light of a second color, and a third sub-pixel emitting light of a third color, and the acquiring the first luminances of the plurality of sub-pixels at the first viewing angle comprises:
enabling the display panel to display a solid color image of the first color;
testing first luminances of all first sub-pixels at the first viewing angle in a one-time whole-surface test mode using a first test device;
enabling the display panel to display a solid color image of the second color;
testing first luminances of all second sub-pixels at the first viewing angle in the one-time whole-surface test mode using the first test device;
enabling the display panel to display a solid color picture of the third color; and
testing first luminances of all third sub-pixels at the first viewing angle in the one-time whole-surface test mode using the first test device.

3. The dark spot detection method according to claim 2, wherein the first viewing angle is a 0° viewing angle.

4. The dark spot detection method according to claim 2, wherein the first test device is a surface photo luminance meter or an imaging luminance meter.

5. The dark spot detection method according to claim 2, wherein the first test device satisfies the following measurement conditions:
$$0.01 < {k}_{1} a \times Nx / f < 0.1 ;$$
$$0.01 < {k}_{2} b \times Ny / f < 0.1 ;$$
$${k}_{1} = nx / Nx ; {k}_{2} = ny / Ny ;$$
wherein a is a length of a light emitting unit in the sub-pixel along a first direction X, b is a length of the light emitting unit in the sub-pixel along a second direction Y, Nx is a quantity of light emitting units in the display panel along the first direction, Ny is a quantity of light emitting units in the display panel along the second direction, f is a lens focal length of the first test device, and nx is a quantity of light emitting units in an effective sampling diameter range of the first test device in a plane perpendicular to a plane where the display panel is located, passing through a center line of the first test device, and parallel to the first direction; ny is a quantity of light emitting units in the effective sampling diameter range of the first test device in a plane perpendicular to the plane where the display panel is located, passing through the center line of the first test device, and parallel to the second direction.

6. The dark spot detection method according to claim 2, wherein a sampling viewing angle of the first test device is greater than or equal to A degrees, and A is between 7 degrees and 10 degrees.

7. The dark spot detection method according to claim 1, wherein the acquiring the first mapping relationship between the first distance and the chief ray angle comprises:
testing chief ray angles of N1 sub-pixels at different first distances using a second test device, wherein N1 is a natural number greater than 2;
obtaining a first mapping formula between the first distance and the chief ray angle by performing formula fitting.

8. The dark spot detection method according to claim 7, wherein when performing the formula fitting on the first mapping relationship between the first distance and the chief ray angle, a curve corresponding to first mapping relationships between two adjacent first distances is a straight line.

9. The dark spot detection method according to claim 7, wherein the second test device is a spot luminance meter.

10. The dark spot detection method according to claim 1, wherein the acquiring luminances of the single sub-pixel at the plurality of viewing angles, and obtaining the second mapping relationship between the viewing angle and the luminance of the single sub-pixel comprises:
testing luminance values of the single sub-pixel at N2 different viewing angles by a second test device, wherein N2 is a natural number greater than 2, and a maximum viewing angle in the N2 different viewing angles is greater than or equal to θ₁°, a minimum viewing angle in the N2 different viewing angle is less than or equal to −θ₂°, where θ₁ equals to a maximum chief ray angle value in chief ray angles of all sub-pixels, −θ₂ equals to a minimum chief ray angle value in the chief ray angles of all the sub-pixels; and
obtaining a second mapping formula of the viewing angle and luminance of the single sub-pixel by performing formula fitting.

11. The dark spot detection method according to claim 10, wherein the single sub-pixel is located at a central position of the display area of the display panel.

12. The dark spot detection method according to claim 1, wherein the determining second luminances of the plurality of sub-pixels at the chief ray angles according to the acquired first luminances, the acquired first mapping relationship, and the acquired second mapping relationship comprises:
determining luminance
$${LV}_{{CRA}_{( {i}_{0} , {j}_{0} )}}$$
of a sub-pixel (i₀, j₀) at a chief ray angle CRA₍ᵢ_{₀}_{,j}_{₀}₎;
for a plurality of sub-pixels (i, j), performing the following operations respectively:
determining a chief ray angle CRA_{(i,j)} of a sub-pixel (i, j) according to the first mapping relationship; calculating luminance
$${LV}_{( {CRA}_{( {i}_{0} , {j}_{0} )} - {CRA}_{( i , j )} )}$$
corresponding to a difference of chief ray angles (CRA₍ᵢ_{₀}_{,j}_{₀}₎−CRA_{(i,j)}) according to the second mapping relationship;
putting luminance L₀_{_{(i,j)}} of the sub-pixel (i, j) at 0° viewing angle, the luminance
$${LV}_{{CRA}_{( {i}_{0} , {j}_{0} )}}$$
of the sub-pixel (i₀, j₀) at the chief ray angle CRA₍ᵢ_{₀}_{,j}_{₀}₎, and the luminance
$${LV}_{( {CRA}_{( {i}_{0} , {j}_{0} )} - {CRA}_{( i , j )} )}$$
corresponding to the difference of chief ray angles (CRA₍ᵢ_{₀}_{,j}_{₀}₎−CRA_{(i,j)}) into the following formula:
$${L}_{{CRA}_{( i , j )}} = {L}_{{0}_{( i , j )}} \frac{{LV}_{{CRA}_{( {i}_{0} , {j}_{0} )}}}{{LV}_{( {CRA}_{( {i}_{0} , {j}_{0} )} - {CRA}_{( i , j )} )}}$$
to obtain second luminance L_{CRA}_{_{(i,j)}} of the sub-pixel (i, j) at the chief ray angle CRA_{(i,j)};
wherein −n₁≤i≤n₂, −m₁≤j≤m₂, n₁+n₂+1 is a quantity of sub-pixel columns, m₁+m₂+1 is a quantity of sub-pixel rows, n₁, n₂, m₁ and m₂ are all natural numbers greater than or equal to 1.

13. The dark spot detection method according to claim 1, wherein the determining second luminances of the plurality of sub-pixels at the chief ray angles according to the acquired first luminances, the acquired first mapping relationship, and the acquired second mapping relationship comprises:
for a plurality of sub-pixels (i, j), performing the following operations respectively:
determining a chief ray angle CRA_{(i,j)} of a sub-pixel (i, j) according to the first mapping relationship;
obtaining a third mapping relationship between the viewing angle and the luminance at the sub-pixel (i, j) according to luminance L₀_{_{(i,j)}} of the sub-pixel (i, j) at 0° viewing angle, the chief ray angle CRA_{(i,j)} of the sub-pixel (i, j) and the second mapping relationship between the viewing angle and the luminance at the single sub-pixel (i₀, j₀), wherein a curve corresponding to the third mapping relationship is a curve symmetric about the chief ray angle CRA_{(i,j)}; and
obtaining second luminance of the sub-pixel (i, j) at the chief ray angle CRA_{(i,j)} according to the third mapping relationship;
wherein −n₁≤i≤n₂, −m₁≤j≤m₂, n₁+n₂+1 is a quantity of sub-pixel columns, m₁+m₂+1 is a quantity of sub-pixel rows, n₁, n₂, m₁ and m₂ are all natural numbers greater than or equal to 1.

14. The dark spot detection method according to claim 1, wherein the luminance threshold comprises any one of a preset luminance value, an average of luminances of a portion of sub-pixels within a first display area, or an average of luminances of all sub-pixels within the first display area, wherein the first display area is an entire display screen or a portion of the entire display screen.

15. A dark spot detection apparatus for a display panel, comprising a memory, and a processor coupled to the memory, wherein the memory is configured to store instructions, and the processor is configured to perform acts of the dark spot detection method for the display panel according to claim 1 based on the instructions stored in the memory.

16. A computer-readable non-volatile storage medium, having stored thereon a computer program wherein, when the computer program is executed by a processor, the dark spot detection method for the display panel according to claim 1 is implemented.

17. A dark spot detection apparatus for a display panel, comprising a processor, wherein the processor is configured to perform the following acts:
acquiring first luminances of a plurality of sub-pixels at a first viewing angle;
acquiring a first mapping relationship between a first distance and a chief ray angle, wherein the first distance is a distance from a sub-pixel to a center of a display area of the display panel, and the chief ray angle is an included angle between a direction in which a luminous intensity of the sub-pixel is greatest and a direction perpendicular to the display panel;
acquiring luminances of a single sub-pixel at a plurality of viewing angles, and obtaining a second mapping relationship between a viewing angle and luminance of the single sub-pixel; and
determining second luminances of the plurality of sub-pixels at chief ray angles according to the acquired first luminances, the acquired first mapping relationship, and the acquired second mapping relationship, and marking a sub-pixel whose second luminance is lower than a luminance threshold as a dark spot.

18. (canceled)

19. The dark spot detection apparatus according to claim 17, wherein acquiring the first mapping relationship between the first distance and the chief ray angle, comprises:
acquiring chief ray angles of N1 sub-pixels at different first distances by testing of a second test device, wherein N1 is a natural number greater than 2;
obtaining a first mapping formula between the first distance and the chief ray angle by performing formula fitting.

20. The dark spot detection apparatus according to claim 17, wherein acquiring luminances of the single sub-pixel at the plurality of viewing angles and obtaining the second mapping relationship between the viewing angle and the luminance of the single sub-pixel, comprises:
acquiring luminance values of the single sub-pixel at N2 different viewing angles by testing of a second test device, wherein N2 is a natural number greater than 2, and a maximum viewing angle in the N2 different viewing angles is greater than or equal to θ₁°, a minimum viewing angle in the N2 different viewing angles is less than or equal to −θ₂°, wherein 01 equals to a maximum principal angle value in chief ray angles of all sub-pixels, and −θ₂ equals to a minimum chief ray angle value in the chief ray angles of all the sub-pixels; and
obtaining the second mapping formula of the viewing angle and luminance of the single sub-pixel by performing formula fitting.

21. The dark spot detection apparatus according to claim 17, wherein determining second luminances of the plurality of the sub-pixels at the chief ray angles according to the acquired first luminances, the acquired first mapping relationship, and the acquired second mapping relationship, comprises:
determining luminance
$${LV}_{{CRA}_{( {i}_{0} , {j}_{0} )}}$$
of a sub-pixel (i₀, j₀) at a chief ray angle CRA₍ᵢ_{₀}_{,j}_{₀}₎;
for a plurality of sub-pixels (i, j), performing the following operations respectively:
determining a chief ray angle CRA_{(i,j)} of a sub-pixel (i, j) according to the first mapping relationship; calculating luminance
$${LV}_{( {CRA}_{( {i}_{0} , {j}_{0} )} - {CRA}_{( i , j )} )}$$
corresponding to a difference of chief ray angles (CRA₍ᵢ_{₀}_{,j}_{₀}₎−CRA_{(i,j)}) according to the second mapping relationship; and
putting luminance L₀_{_{(i,j)}} of the sub-pixel (i, j) at 0° viewing angle, the luminance
$${LV}_{{CRA}_{( {i}_{0} , {j}_{0} )}}$$
of the sub-pixel (i₀, j₀) at the chief ray angle CRA₍ᵢ_{₀}_{,j}_{₀}₎, and the luminance
$${LV}_{( {CRA}_{( {i}_{0} , {j}_{0} )} - {CRA}_{( i , j )} )}$$
corresponding to the difference of chief ray angles (CRA₍ᵢ_{₀}_{,j}_{₀}₎−CRA_{(i,j)}) into the following formula
$${L}_{{CRA}_{( i , j )}} = {L}_{{0}_{( i , j )}} \frac{{LV}_{{CRA}_{( {i}_{0} , {j}_{0} )}}}{{LV}_{( {CRA}_{( {i}_{0} , {j}_{0} )} - {CRA}_{( i , j )} )}}$$
to obtain second luminance L_{CRA}_{_{(i,j)}} of the sub-pixels (i, j) at the chief ray angle CRA_{(i,j)};
wherein −n₁≤i≤n₂, −m₁≤j≤m₂, n₁+n₂+1 is a quantity of sub-pixel columns, m₁+m₂+1 is a quantity of sub-pixel rows, n₁, n₂, m₁ and m₂ are all natural numbers greater than or equal to 1.

22. (canceled)
